(19) United States
(12) Patent Application Publication
(10) Pub. No.: US 2024/0178567 A1
(43) Pub. Date: May 30, 2024

(54) ANTENNA MODULE AND COMMUNICATION APPARATUS EQUIPPED WITH THE SAME

(71) Applicant: Murata Manufacturing Co., Ltd., Nagaokakyo-shi (JP)

(72) Inventor: Yosuke SATO, Nagaokakyo-shi (JP)

(73) Assignee: Murata Manufacturing Co., Ltd., Nagaokakyo-shi (JP)

(21) Appl. No.: 18/437,314

(22) Filed: Feb. 9, 2024

Related U.S. Application Data
(63) Continuation of application No. PCT/JP2022/029830, filed on Aug. 3, 2022.

(30) Foreign Application Priority Data
Aug. 31, 2021 (JP) 2021-140567

(51) Int. Cl. H01Q 9/04; H01Q 19/00

(52) U.S. Cl. CPC H01Q 9/0428; H01Q 19/005

(57) ABSTRACT

An antenna module including a passive element, a ground electrode, a feed element, a feed line, and a feed line. The feed element includes a radiating electrode and a radiating electrode. The feed lines pass through respective through holes formed in the passive element and are connected to the radiating electrode, respectively. The feed element radiates radio waves in a second frequency band higher than a first frequency band of radio waves radiated by the passive element. The passive element is capable of radiating radio waves including polarized waves in a first polarization direction and polarized waves in a second polarization direction. The polarization direction of the radiating electrode and the polarization direction of the radiating electrode differ from each other.

### CROSS-REFERENCE TO RELATED APPLICATIONS

This is a continuation application of PCT/JP2022/029830, filed on Aug. 3, 2022, designating the United States of America, which is based on and claims priority to Japanese Patent Application No. JP 2021-140567 filed on Aug. 31, 2021. The entire contents of the above-identified applications, including the specifications, drawings and claims, are incorporated herein by reference in their entirety.

### TECHNICAL FIELD

The present disclosure relates to a dual-polarization type antenna module including an antenna having a stack structure in which a feed line is shared and, more particularly, to a technique for improving antenna characteristics.

### BACKGROUND ART

U.S. Patent Application Publication No. 2020/0106183 (Patent Document 1) discloses a stacked antenna in which two patch antennas are stacked. The two patch antennas radiate respective radio waves in different frequency bands.

The stacked antenna disclosed in Patent Document 1 is a dual-polarization type antenna and radiates radio waves in two different polarization directions. Radio waves in the two polarization directions are radiated in accordance with respective signals supplied from two feed lines. One of the two patch antennas disclosed in Patent Document 1 is directly connected to the two feed lines, and the other one of them is capacitively coupled to the two feed lines. That is, the feed lines are shared between the two patch antennas.

### CITATION LIST

### Patent Document

Patent Document 1: U.S. Patent Application Publication No. 2020/0106183

### Summary of Disclosure

### Technical Problem

In recent years, signals in various frequency bands have been used in communications and the use of radio waves in higher frequency bands have been promoted. For the transmission and reception of signals in high frequency bands, a patch antenna is reduced in size.

However, in the case of a dual-band stacked patch antenna including two patch antennas with respective frequency bands between which there is a large difference, the difference in size between the two patch antennas is large. In the case where the two patch antennas are disposed such that the respective centers thereof overlap assuming such a stacked patch antenna is viewed in plan and a feed line is shared between the two patch antennas, the feeding point of the larger patch antenna approaches the center of the patch antenna. That is, impedance matching cannot be appropriately performed. This may lead to the increase in loss and the decrease in bandwidth.

The present disclosure has been made to solve such a problem, and it is an object of the present disclosure to improve antenna characteristics in a dual-polarization type antenna module including an antenna having a stack structure in which a feed line is shared.

### Solution to Problem

An antenna module according to an aspect of the present disclosure includes a flat-shaped support substrate, a passive element, a ground electrode, a feed element, a first feed line, and a second feed line. The passive element is disposed in the support substrate. The ground electrode faces the passive element. The feed element faces the ground electrode and includes a first radiating electrode and a second radiating electrode. The first feed line passes through a through hole formed in the passive element and is connected to the first radiating electrode. The second feed line passes through a through hole formed in the passive element and is connected to the second radiating electrode. The passive element radiates a radio wave in a first frequency band. The feed element radiates a radio wave in a second frequency band higher than the first frequency band. The passive element is disposed between the ground electrode and the feed element in a normal direction of the support substrate. The passive element is capable of radiating a radio wave in a first polarization direction based on a radio frequency signal supplied to the first feed line and a radio wave in a second polarization direction based on a radio frequency signal supplied to the second feed line. A polarization direction of the first radiating electrode and a polarization direction of the second radiating electrode differ from each other.

### Advantageous Effects of Disclosure

An antenna module according to the present disclosure includes a dual-polarization type antenna having a stack structure in which a feed element and a passive element are stacked. A frequency band radiated by the feed element is higher than a frequency band radiated by the passive element. The feed element on a higher-frequency side includes the two separate radiating electrodes. Radio frequency signals are supplied to the radiating electrodes through respective feed lines passing through the passive element. Since through holes of the passive element in which the feed lines pass through can be placed at respective positions appropriate for impedance matching with such a configuration, antenna characteristics can be improved.

### BRIEF DESCRIPTION OF DRAWINGS

FIG. 1 is an exemplary block diagram of a communication apparatus to which an antenna module according to a first embodiment is applied.

FIG. 2 is a plan view (FIG. 2 (A)) and a side perspective view (FIG. 2 (B)) of an antenna device according to the first embodiment.

FIG. 3 is a plan view (FIG. 3 (A)) and a side perspective view (FIG. 3 (B)) of an antenna device according to a comparative example.

FIG. 4 is a plan view (FIG. 4 (A)) and a side perspective view (FIG. 4 (B)) of an antenna module according to a second embodiment.

FIG. 5 is a plan view (FIG. 5 (A)) and a side perspective view (FIG. 5 (B)) of an antenna module according to a third embodiment.

FIG. 6 is a plan view (FIG. 6 (A)) and a side perspective view (FIG. 6 (B)) of an antenna module according to a fourth embodiment.

FIG. 7 is a plan view of an antenna module according to a fifth embodiment.

FIG. 8 is a diagram describing a principle of occurrence of grating lobes.

FIG. 9 is a graph indicating conditions under which a grating lobe θ1 occurs.

FIG. 10 is a plan view of an antenna module according to a sixth embodiment.

FIG. 11 is a plan view (FIG. 11 (A)) and a side perspective view (FIG. 11 (B)) of an antenna module according to a seventh embodiment.

FIG. 12 is a plan view (FIG. 12 (A)) and a side perspective view (FIG. 12 (B)) of an antenna module according to an eighth embodiment.

FIG. 13 is a plan view (FIG. 13 (A)) and a side perspective view (FIG. 13 (B)) of an antenna module according to a ninth embodiment.

FIG. 14 is a plan view (FIG. 14 (A)) and a side perspective view (FIG. 14 (B)) of an antenna module according to a tenth embodiment.

### DESCRIPTION OF EMBODIMENTS

Embodiments of the present disclosure will be described in detail below with reference to drawings. The same reference numeral is used to represent the same part or the corresponding part in the drawings, and the description thereof will not be repeated.

### First Embodiment

### Basic Configuration of Communication Apparatus

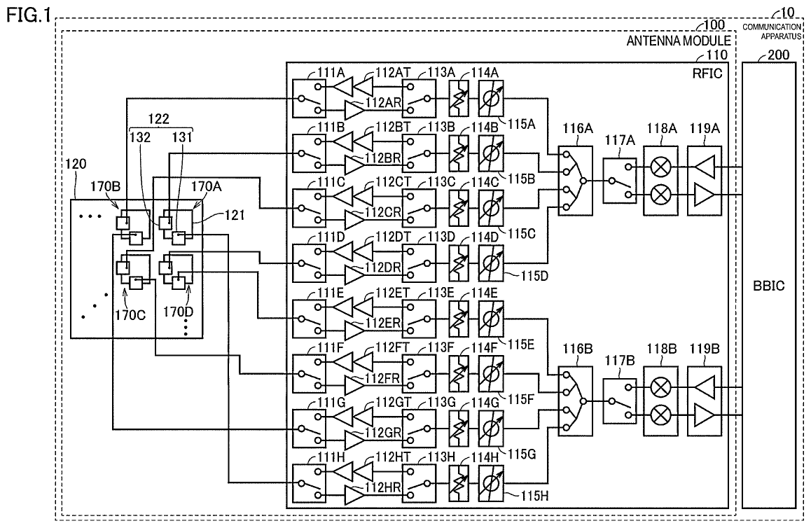

FIG. 1 is an exemplary block diagram of a communication apparatus 10 to which an antenna module 100 according to the first embodiment is applied. The communication apparatus 10 is, for example, a mobile terminal such as a smartphone or a tablet computer or a personal computer having a communication function. An example of a frequency band of radio waves used in the antenna module 100 according to the first embodiment is a radio wave in a millimeter wave band in which, for example, 28 GHZ, 39 GHz, or 60 GHz is a center frequency, but the present disclosure is applicable to radio waves in a frequency band other than the above frequency band.

As illustrated in FIG. 1, the communication apparatus 10 includes the antenna module 100 and a BBIC 200 forming a baseband signal processing circuit. The antenna module 100 includes an RFIC 110, which is an example of a feed circuit, and an antenna device 120. The communication apparatus 10 up-converts a signal transmitted from the BBIC 200 to the antenna module 100 into a radio frequency signal and radiates the radio frequency signal from the antenna device 120, and down-converts a radio frequency signal received by the antenna device 120 and processes the radio frequency signal in the BBIC 200.

In FIG. 1, for ease of explanation, a configuration is illustrated that corresponds to four radiating elements 170A to 170D (hereinafter collectively referred to as a “radiating element 170” in some cases) among a plurality of radiating elements (including passive elements and feed elements) forming the antenna device 120, and the illustration of a configuration corresponding to another radiating element having a similar configuration is omitted. The radiating element 170 includes a passive element 121 and a feed element 122. The feed element 122 includes a radiating electrode 131 and a radiating electrode 132. FIG. 1 illustrates the case where the antenna device 120 is formed of the multiple radiating elements 170 arranged in a two-dimensional array, but the antenna device 120 may be formed of a one-dimensional array of the multiple radiating elements 170 arranged in a line. The antenna device 120 may be formed by the single radiating element 170. In the first embodiment, the radiating element 170 is a flat-shaped patch antenna.

The antenna device 120 is a so-called dual-polarization type antenna device capable of radiating two radio waves having different polarization directions. The passive element 121 can radiate two radio waves having different polarization directions. A radio frequency signal for first polarization and a radio frequency signal for second polarization are supplied from the RFIC 110 to the passive element 121 by capacitive coupling.

Each of the radiating electrodes 131 and 132 radiates radio waves having a single polarization direction. A radio frequency signal for the first polarization direction is supplied from the RFIC 110 to the radiating electrode 131. A radio frequency signal for the second polarization direction is supplied from the RFIC 100 to the radiating electrode 132.

The RFIC 110 includes switches 111A to 111H, 113A to 113H, 117A, and 117B, power amplifiers 112AT to 112HT, low-noise amplifiers 112AR to 112HR, attenuators 114A to 114H, phase shifters 115A to 115H, signal synthesizers/demultiplexers 116A and 116B, mixers 118A and 118B, and amplification circuits 119A and 119B.

Among these components, the configuration of the switches 111A to 111D and 113A to 113D, the power amplifiers 112AT to 112DT, the low-noise amplifiers 112AR to 112DR, the attenuators 114A to 114D, the phase shifters 115A to 115D, the signal synthesizer/demultiplexer 116A, the mixer 118A, and the amplification circuit 119A is a circuit for radio frequency signals for the first polarization. The configuration of the switches 111E to 111H and 113E to 113H, the power amplifiers 112ET to 112HT, the low-noise amplifiers 112ER to 112HR, the attenuators 114E to 114H, the phase shifters 115E to 115H, the signal synthesizer/demultiplexer 116B, the mixer 118B, and the amplification circuit 119B is a circuit for radio frequency signals for the second polarization.

Assuming a radio frequency signal is transmitted, the switches 111A to 111H and 113A to 113H are switched to sides on which the power amplifiers 112AT to 112HT are located, respectively, and the switches 117A and 117B are connected to transmission-side amplifiers in the amplification circuits 119A and 119B, respectively. Assuming a radio frequency signal is received, the switches 111A to 111H and 113A to 113H are switched to sides on which the low-noise amplifiers 112AR to 112HR are located, respectively, and the switches 117A and 117B are connected to reception-side amplifiers in the amplification circuits 119A and 119B, respectively.

A signal transmitted from the BBIC 200 is amplified by the amplification circuit 119A and up-converted by the mixer 118A or amplified by the amplification circuit 119B and up-converted by the mixer 118B. A transmission signal, which is an up-converted radio frequency signal, is split into four signals by the signal synthesizer/demultiplexer 116A, and the signals pass through corresponding signal paths and are fed to the different radiating elements 170. A transmission signal, which is an up-converted radio frequency signal, is split into four signals by the signal synthesizer/demultiplexer 116B, and the signals pass through corresponding signal paths and are fed to the different radiating elements 170. By individually adjusting a phase shift degree of each of the phase shifters 115A to 115H disposed in the respective signal paths, the directivity of the antenna device 120 can be adjusted. Each of the attenuators 114A to 114H adjusts the intensity of a transmission signal.

Radio frequency signals from the switches 111B and 111H are supplied to the radiating element 170A. Radio frequency signals from the switches 111A and 111G are supplied to the radiating element 170B. Radio frequency signals from the switches 111C and 111F are supplied to the radiating element 170C. Radio frequency signals from the switches 111D and 111E are supplied to the radiating element 170D.

Reception signals, which are radio frequency signals, received by the respective radiating elements 170 are transmitted to the RFIC 110, pass through different signal paths, and synthesized by the signal synthesizer/demultiplexer 116A, or reception signals received by the respective radiating elements 170 are transmitted to the RFIC 110, pass through different signal paths, and synthesized by the signal synthesizer/demultiplexer 116B. A synthesized reception signal is down-converted by the mixer 118A and amplified by the amplifier circuit 119A or down-converted by the mixer 118B and amplified by the amplifier circuit 119B, and the signal is transmitted to the BBIC 200.

### Configuration of Antenna Module

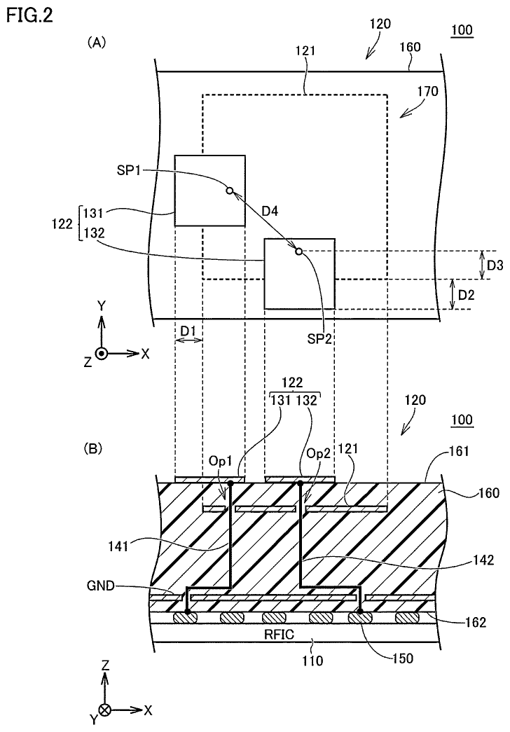

Next, the passive element 121 and the feed element 122 included in the antenna module 100 according to the first embodiment will be described in detail with reference to FIG. 2. FIG. 2 is a plan view (FIG. 2 (A)) and a side perspective view (FIG. 2 (B)) of the antenna device 120 according to the first embodiment. The antenna module 100 according to the first embodiment includes the radiating element 170, the RFIC 110, a support substrate 160, feed lines 141 and 142, and a ground electrode GND. The radiating element 170 includes the passive element 121 and the feed element 122.

In the following description, a normal direction of the support substrate 160 (direction of radio wave radiation) is referred to as a “Z-axis direction”, and a plane perpendicular to the Z-axis direction is defined as an X axis and a Y axis. A direction along the longitudinal direction of the support substrate 160 assuming the support substrate 160 is viewed in plan is referred to as an X-axis direction, and a direction perpendicular to the X axis is referred to as a Y-axis direction. A positive direction and a negative direction of the Z axis in each drawing may be referred to as an upper side and a lower side, respectively.

The support substrate 160 has a plane parallel to the XY plane. The support substrate 160 is, for example, a low temperature co-fired ceramics (LTCC) multilayer substrate, a multilayer resin substrate formed by laminating a plurality of resin layers made of a resin such as epoxy or polyimide, a multilayer resin substrate formed by laminating a plurality of resin layers made of a liquid crystal polymer (LCP) having a lower dielectric constant, a multilayer resin substrate formed by laminating a plurality of resin layers made of a fluorine-based resin, a multilayer resin substrate formed by laminating a plurality of resin layers made of a polyethylene terephthalate (PET) material, or a ceramic multilayer substrate other than an LTCC multilayer substrate. The support substrate 160 does not necessarily have a multilayer structure and may be a single-layer substrate.

The support substrate 160 has a rectangular shape having long sides in the X-axis direction as viewed from the normal direction (the Z-axis direction). As illustrated in FIG. 2 (A), the illustration of a part of the support substrate 160 extending in the X-axis direction is omitted for ease of explanation.

As illustrated in FIG. 2 (A), the feed element 122 is disposed on the upper surface 161 (surface in the Z-axis positive direction) of the support substrate 160. That is, the feed element 122 is disposed to be exposed on the surface of the support substrate 160 in an aspect. Alternatively, the feed element 122 may be disposed in the support substrate 160. As described above, the feed element 122 includes the radiating electrodes 131 and 132. That is, the feed element 122 includes two separate radiating electrodes. The passive element 121 is disposed in a layer close to the upper surface 161 of the support substrate 160 (an upper-side layer) in the support substrate 160.

Since the frequency band of a radio wave radiated by the radiating electrode 131 is the same as that of a radio wave radiated by the radiating electrode 132, the radiating electrode 131 is equal in size to the radiating electrode 132. The size of the radiating electrodes 131 and 132 is smaller than that of the passive element 121. That is, the frequency of radio waves radiated from the radiating electrodes 131 and 132 are higher than that of radio waves radiated from the passive element 121. In the first embodiment, the center frequency of radio waves radiated from the radiating electrodes 131 and 132 is 60 GHZ, and the center frequency of radio waves radiated from the passive element 121 is 28 GHz. That is, the feed element 122 radiates radio waves of frequencies on a higher-frequency side, and the passive element 121 radiates radio waves of frequencies on a lower-frequency side.

The ground electrode GND is disposed across the entire surface of the support substrate 160 at a position near an undersurface 162 (surface in the Z-axis negative direction) of the support substrate 160. That is, as illustrated in FIG. 2 (B), the ground electrode GND, the passive element 121, and the feed element 122 are disposed in this order from the Z-axis negative direction. The ground electrode GND faces each of the radiating electrodes 131 and 132 and the passive element 121. That is, in the first embodiment, the passive element 121 is disposed in a layer between the feed element 122 and the ground electrode GND.

As illustrated in FIG. 2 (A), a part of the radiating electrode 131 in the X-axis positive direction is disposed at a position overlapping the passive element 121 and a part of the radiating electrode 131 in the X-axis negative direction is disposed at a position not overlapping the passive element 121 assuming the support substrate 160 is viewed in plan. That is, a side of the radiating electrode 131 in the X-axis negative direction is offset from a side of the passive element 121 in the X-axis negative direction by a distance D1.

Assuming the support substrate 160 is viewed in plan, a part of the radiating electrode 132 in the Y-axis positive direction is disposed at a position overlapping the passive element 121 and a part of the radiating electrode 132 in the Y-axis negative direction is disposed at a position not overlapping the passive element 121. That is, assuming the support substrate 160 is viewed in plan, a side of the radiating electrode 132 in the Y-axis negative direction is offset from a side of the passive element 121 in the Y-axis negative direction by a distance D2.

The RFIC 110 is disposed on the undersurface 162 of the support substrate 160 via a solder bump 150. The RFIC 110 may be connected to the support substrate 160 using a multi-pole connector and a flexible substrate instead of the solder connection.

Each of the radiating electrodes 131 and 132 and the passive element 121 is a flat-shaped electrode with a substantially square shape. Radio frequency signals are supplied from the RFIC 110 to the radiating electrodes 131 and 132 via the feed lines 141 and 142, respectively. The feed line 141 passes through a through hole formed to pass through the RFIC 110, the ground electrode GND, and the passive element 121 and is coupled to a feeding point SP1 of the radiating electrode 131. The feed line 142 passes through a through hole formed to pass through the RFIC 110, the ground electrode GND, and the passive element 121 and is coupled to a feeding point SP2 of the radiating electrode 132. In the passive element 121, the feed lines 141 and 142 are formed as openings Op1 and Op2, respectively.

A part of the feed line 141 extends along a straight line connecting the opening Op1 and the feeding point SP1. A part of the feed line 142 extends along a straight line connecting the opening Op2 and the feeding point SP2. That is, each of the parts of the feed lines 141 and 142 is disposed on the shortest route between the corresponding through hole and the corresponding feeding point. Accordingly, the attenuation of radio frequency signals supplied to the feed lines 141 and 142 can be suppressed, and the occurrence of a loss and unwanted radiation can be suppressed.

As illustrated in FIG. 2 (A), the feeding point SP1 is offset from the center of the radiating electrode 131 in the X-axis positive direction. The radiating electrode 131 therefore radiates in the normal direction of the support substrate 160 radio waves having a polarization direction in the X-axis direction. The feeding point SP2 is offset from the center of the radiating electrode 132 in the Y-axis positive direction. The radiating electrode 132 therefore radiates in the normal direction of the support substrate 160 radio waves having a polarization direction in the Y-axis direction. The radiating electrodes 131 and 132 may radiate radio waves including polarized waves in a direction obliquely intersecting the X axis or the Y axis or may radiate circularly polarized waves.

Assuming the support substrate 160 is viewed in plan, the feeding point SP2 is offset from the side of the passive element 121 in the Y-axis negative direction in the Y-axis positive direction by a distance D3. Assuming the support substrate 160 is viewed in plan, the feeding point SP2 overlaps the opening Op2. Accordingly, the opening Op2 is offset from the side of the passive element 121 in the Y-axis negative direction in the Y-axis positive direction by the distance D3. Although not illustrated, the opening Op1 is also offset from the side of the passive element 121 in X-axis negative direction in the X-axis positive direction by the distance D3 assuming the support substrate 160 is viewed in plan.

Assuming a radio frequency signal corresponding to the resonant frequency of the passive element 121 is supplied to the feed line 141, the feed line 141 and the passive element 121 are electromagnetically coupled to each other at a penetrating position (the opening Op1) of the passive element 121 and the passive element 121 is excited. As a result of this, the passive element 121 radiates radio waves having a polarization direction in the X-axis direction. Assuming a radio frequency signal corresponding to the resonant frequency of the passive element 121 is supplied to the feed line 142, the feed line 142 and the passive element 121 are electromagnetically coupled to each other at the through hole (the opening Op2) of the passive element 121 and the passive element 121 is excited. As a result of this, the passive element 121 radiates radio waves having a polarization direction in the Y-axis direction. That is, the feed element 122 and the passive element 121 share the feed lines 141 and 142. The polarization direction in the X-axis direction corresponds to a “first polarization direction” in the present disclosure, and the polarization direction in the Y-axis direction corresponds to a “second polarization direction” in the present disclosure.

Thus, in the antenna module 100 according to the first embodiment, the feed element 122 on a higher-frequency side includes the separate radiating electrodes 131 and 132 for respective polarization directions. A distance between the feed line 141 coupled to the radiating electrode 131 and the feed line 142 coupled to the radiating electrode 132 is represented as a distance D4 in Fig. FIG. 2 (A). Assuming the distance between the feed line 141 coupled to the radiating electrode 131 and the feed line 142 coupled to the radiating electrode 132 shortens, signals supplied to the feed lines 141 and 142 are easily electromagnetically coupled to each other.

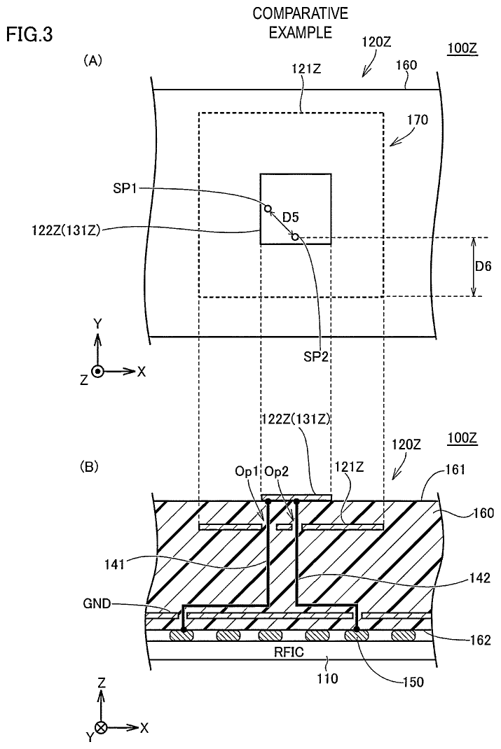

FIG. 3 is a plan view (FIG. 3 (A)) and a side perspective view (FIG. 3 (B)) of an antenna device 120Z according to a comparative example. FIG. 3 illustrates the antenna device 120Z included in an antenna module 100Z according to the comparative example. In the antenna device 120Z according to the comparative example, a feed element 122Z on a higher-frequency side does not include two radiating electrodes but a single radiating electrode 131Z.

The antenna module 100Z according to the comparative example radiates radio waves of frequencies, which are the same as those of radio waves radiated by the antenna module 100 according to the first embodiment, on both a higher-frequency side and a lower-frequency side. That is, also in the antenna module 100Z according to the comparative example, the center frequency of radio waves radiated from the radiating electrode 131Z is 60 GHZ and the center frequency of radio waves radiated from the passive element 121 is 28 GHz. Accordingly, the size of the radiating electrode 131Z according to the comparative example is the same as that of the radiating electrodes 131 and 132 in the first embodiment.

The radiating electrode 131Z according to the comparative example includes the feeding point SP1 and the feeding point SP2 to radiate radio waves having polarization directions in the X-axis direction and the Y-axis direction. That is, in the comparative example, the feed lines 141 and 142 pass through the RFIC 110, the ground electrode GND, and the passive element 121 and are coupled to the feeding points SP1 and SP2 of the radiating electrode 131Z, respectively.

Accordingly, as illustrated in FIG. 3 (A), the distance between the feed lines 141 and 142 connected to the feed element 122Z on a higher-frequency side is a distance D5. The distance D5 is shorter than the distance D4 illustrated in FIG. 2 (A). In the comparative example, the feeding point SP2 is offset from the side of the passive element 121 in the Y-axis negative direction in the Y-axis positive direction by a distance D6 assuming the support substrate 160 is viewed in plan. Assuming the support substrate 160 is viewed in plan, the feeding point SP2 overlaps the opening Op2. Accordingly, the opening Op2 is offset from the side of the passive element 121 in the Y-axis negative direction in the Y-axis positive direction by the distance D6. The distance D6 is longer than the distance D3 illustrated in FIG. 2 (A).

Thus, in the antenna module 100 according to the first embodiment, the feed element 122 on a higher-frequency side includes the separate radiating electrodes 131 and 132 for respective polarization directions. The distance D4 between the feed lines 141 and 142 connected to the feed element 122 on a higher-frequency side is longer than the distance D5 between the feed lines 141 and 142 in the comparative example. Accordingly, in the antenna module 100 according to the first embodiment, the electromagnetic coupling between signals supplied to the feed lines 141 and 142 can be suppressed and the loss of a radio frequency signal transmitted by the feed line 141 or 142 can be suppressed. The antenna module 100 according to the first embodiment can therefore improve the isolation between radio waves in different polarization directions and improve antenna characteristics.

The through holes (the openings Op1 and Op2) of the passive element 121 in the first embodiment are disposed at respective positions closer to end portions of the passive element 121 as compared with the through holes of the passive element 121Z according to the comparative example. That is, in the first embodiment, the distance D3 between the through hole (the opening Op2) and the side of the passive element 121 in the Y-axis negative direction is shorter than the distance D6 in the comparative example.

In a square patch antenna, an input impedance is adjusted by changing the position of a feeding point. Assuming a feeding point is located at the center of a square patch antenna, an input impedance is zero. That is, it is difficult to perform impedance matching assuming a feeding point is located near the center of a square patch antenna. Assuming impedance matching is not performed, a return loss increases. This leads to the decrease in bandwidth. Accordingly, from the viewpoint of impedance adjustment, it is desired that, for impedance matching, the position of a feeding point be located at a position closer to an end portion of a patch antenna than to the center of the patch antenna.

In the antenna module 100 according to the first embodiment in which the feed element 122 on a higher-frequency side includes the two separate radiating electrodes 131 and 132, the constraints on the positions of through holes (the openings Op1 and Op2) of the passive element 121 are eased and through holes (the openings Op1 and Op2) can therefore be disposed at appropriate positions in the passive element 121. As a result, in the antenna module 100 according to the first embodiment, an opening impedance can be easily adjusted and a desired frequency bandwidth can be achieved.

### Second Embodiment

The configuration has been described in the first embodiment in which the radiating electrode 131 radiates radio waves having a polarization direction in the X-axis direction and the radiating electrode 132 radiates radio waves having a polarization direction in the Y-axis direction. In the second embodiment, a configuration will be described in which the polarization directions of radio waves radiated by the radiating electrodes 131 and 132 are exchanged.

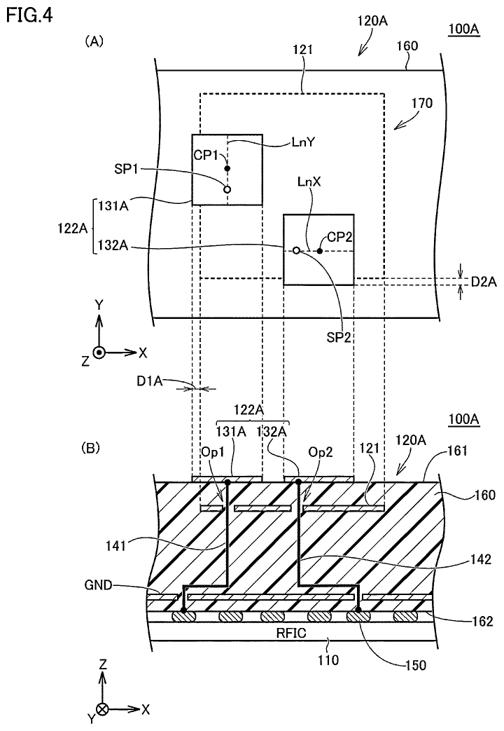

FIG. 4 is a plan view (FIG. 4 (A)) and a side perspective view (FIG. 4 (B)) of an antenna module 100A according to the second embodiment. The description of a configuration that is the same as that of the antenna module 100 in FIG. 2 is not repeated with reference to FIG. 4.

As illustrated in FIG. 4, a feed element 122A in the antenna module 100A includes a radiating electrode 131A and a radiating electrode 132A. The feeding point SP1 of the radiating electrode 131A is offset from the center of the radiating electrode 131A in the Y-axis negative direction. The radiating electrode 131A therefore radiates radio waves having a polarization direction in the Y-axis direction. The feeding point SP2 of the radiating electrode 132A is offset from the center of the radiating electrode 132A in the X-axis negative direction. The radiating electrode 132A therefore radiates radio waves having a polarization direction in the X-axis direction.

In the example illustrated in FIG. 4, the feeding point SP1 of the radiating electrode 131A is disposed at a position that is offset from a center point CP1 of the radiating electrode 131A in a direction approaching the radiating electrode 132A on a straight line LnY passing through the center point CP1 of the radiating electrode 131A along the Y-axis direction. That is, the feeding point SP1 is disposed at a position offset from the center point CP1 in the Y-axis negative direction. That is, the center point CP1, the feeding point SP1, and a center point CP2 are disposed in this order from the Y-axis positive direction to the Y-axis negative direction.

The feeding point SP2 of the radiating electrode 132A is disposed at a position that is offset from the center point CP2 of the radiating electrode 132A in a direction approaching the radiating electrode 131A on a straight line LnX passing through the center point CP2 of the radiating electrode 132A along the X-axis direction. That is, the feeding point SP2 is disposed at a position offset from the center point CP2 in the X-axis negative direction. That is, the center point CP2, the feeding point SP2, and the center point CP1 are disposed in this order from the X-axis positive direction to the X-axis negative direction.

The radiating electrode 131A may be disposed at a position where the radiating electrode 131A illustrated in FIG. 4 is rotated 180 degrees with the feeding point SP1 of the radiating electrode 131A as a pivot. In this case, on the radiating electrode 131A, the feeding point SP1 is not disposed between the center point CP1 of the radiating electrode 131A and the center point CP2 of the radiating electrode 132A along the Y-axis direction from the center point CP1 of radiating electrode 131A. The feeding point SP1, the center point CP1, and the center point CP2 are disposed in this order from the Y-axis positive direction to the Y-axis negative direction. The radiating electrode 132A may also be disposed at a position where the radiating electrode 132A illustrated in FIG. 4 is rotated 180 degrees with the feeding point SP2 of the radiating electrode 132A as a pivot.

As compared with the case where at least one of the radiating electrode 131A or 131B is disposed at a position where the radiating electrode is rotated 180 degrees with the feeding point as a pivot from the state illustrated in FIG. 4, the distance between the radiating electrodes 131A and 132A increases in the antenna module 100A in which the feeding points SP1 and SP2 and the center points CP1 and CP2 are arranged as illustrated in FIG. 4. Accordingly, the antenna module 100A illustrated in FIG. 4 can suppress the electromagnetic coupling between signals supplied to the radiating electrodes 131A and 132A. That is, in the antenna module 100A according to the second embodiment, the isolation between radio waves having different polarization directions can be improved and antenna characteristics can be improved.

In comparison between FIGS. 2 (A) and 4 (A), the radiating electrode 131A according to the second embodiment is disposed at a position where the radiating electrode 131 according to the first embodiment is rotated 90 degrees clockwise with the feeding point SP1 of the radiating electrode 131 as a pivot. The radiating electrode 132A according to the second embodiment is disposed at a position where the radiating electrode 132 according to the first embodiment is rotated 90 degrees counterclockwise with the feeding point SP2 of the radiating electrode 132 as a pivot. In comparison between FIGS. 2 (A) and 4 (A), the respective positions at which the feeding points SP1 and SP2 and the openings Op1 and Op2 are formed are the same. That is, in the antenna module 100A according to the second embodiment, the radiating electrodes 131A and 132A are disposed differently from the radiating electrodes 131 and 132 according to the first embodiment, respectively.

In the second embodiment, as illustrated in FIG. 4 (A), the radiating electrode 131A is disposed at a position where the side of the radiating electrode 131A in the X-axis negative direction is offset from the side of the passive element 121 in the X-axis negative direction by a distance D1A assuming the support substrate 160 is viewed in plan. Assuming the support substrate 160 is viewed in plan, the radiating electrode 132A is disposed at a position where the side of the radiating electrode 132A in the Y-axis negative direction is offset from the side of the passive element 121 in the Y-axis negative direction by a distance D2A.

Thus, also in the antenna module 100A according to the second embodiment in which the feed element 122A on a higher-frequency side includes the two separate radiating electrodes 131A and 132A, the constraints on the positions of through holes (the openings Op1 and Op2) of the passive element 121 are eased. As a result, impedance adjustment can be easily performed and a desired frequency bandwidth can be achieved. Also in the antenna module 100A according to the second embodiment, the electromagnetic coupling between signals supplied to the feed lines 141 and 142 can be suppressed. The antenna module 100A according to the second embodiment can therefore improve the isolation between radio waves in different polarization directions and improve antenna characteristics.

The passive element 121 radiates radio waves having a polarization direction in the X-axis direction on the basis of a radio frequency signal transmitted from the feed line 141. The radiating electrode 131A radiates radio waves having a polarization direction in the Y-axis direction on the basis of a radio frequency signal transmitted from the feed line 141. Thus, the polarization directions of radio waves radiated from the passive element 121 and the feed element 122A on the basis of radio frequency signals supplied from the common feed line 141 differ from each other. The polarization directions of radio waves radiated from the passive element 121 and the feed element 122A on the basis of radio frequency signals supplied from the common feed line 142 also differ from each other. Assuming supplying a signal of a frequency on a higher-frequency side, the antenna module 100A according to the second embodiment can suppress the influence of unwanted radiation of the passive element 121 on a lower-frequency side upon radio waves radiated from the feed element 122A on a higher-frequency side as noise. Assuming supplying a signal of a frequency on a lower-frequency side, the antenna module 100A according to the second embodiment can also suppress the influence of unwanted radiation of the feed element 122A on a higher-frequency side upon radio waves radiated from the passive element 121 on a lower-frequency side as noise.

In the antenna module 100A according to the second embodiment, the area where the radiating electrode 131A and the passive element 121 overlap is larger than the area where the radiating electrode 131 and the passive element 121 overlap in the first embodiment. That is, in the second embodiment, the area where the radiating electrode 131A and the ground electrode GND overlap decrease as compared with the first embodiment. Accordingly, the influence of the capacitive coupling between the radiating electrode 131A and the ground electrode GND upon the impedance of the radiating electrode 131A is small in the second embodiment. In the antenna module 100A according to the second embodiment, impedance matching can therefore be easily performed. In the antenna module 100A according to the second embodiment, the radiating electrodes 131A and 132A are disposed closer to the center of the passive element 121 as compared with the first embodiment assuming the support substrate 160 is viewed in plan. Accordingly, the antenna module 100A itself according to the second embodiment can be miniaturized.

### Third Embodiment

The configuration has been described in the first and second embodiments in which at least parts of the radiating electrodes 131 and 132 overlap the passive element 121. In the third embodiment, the configuration will be described in which radiating electrodes 131B and 132B do not overlap the passive element 121.

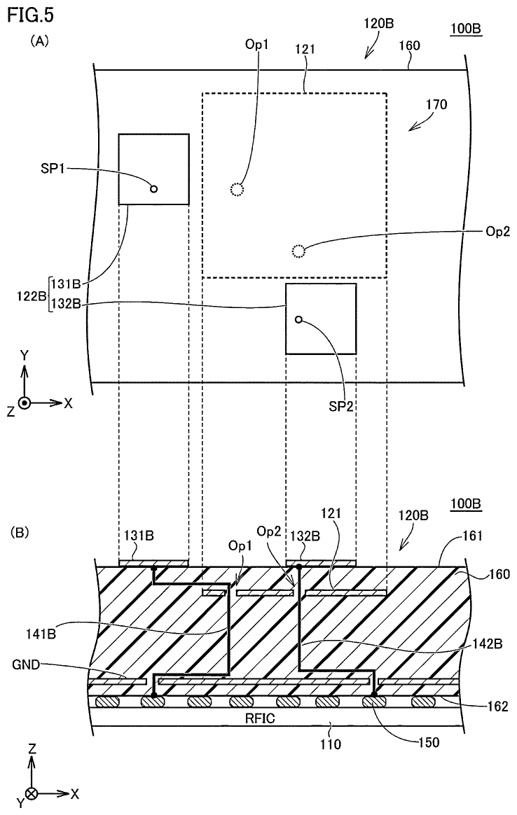

FIG. 5 is a plan view (FIG. 5(A)) and a side perspective view (FIG. 5(B)) of an antenna module 100B according to the third embodiment. The description of a configuration that is the same as that of the antenna module 100A in FIG. 4 is not repeated with reference to FIG. 5.

As illustrated in FIG. 5, a feed element 122B includes the radiating electrodes 131B and 132B in the antenna module 100B. The radiating electrodes 131B and 132B are disposed at respective positions not overlapping the passive element 121 assuming the support substrate 160 is viewed in plan. Also in FIG. 5, the passive element 121 is disposed between the ground electrode GND and the feed element 122B in the Z-axis direction.

That is, the length of a feed line 141B between the opening Op1 and the radiating electrode 131B in the X-axis direction in the third embodiment is longer than the length of the feed line 141 between the opening Op1 and the radiating electrode 131 in the X-axis direction in the first embodiment. The length of a feed line 142B between the opening Op2 and the radiating electrode 132B in the Y-axis direction in the third embodiment is also longer than the length of the feed line 142 between the opening Op2 and the radiating electrode 132 in the Y-axis direction in the first embodiment.

Thus, also in the case of the configuration according to the third embodiment in which the radiating electrodes 131B and 132B do not overlap the passive element 121, the constraints on the positions of through holes (the openings Op1 and Op2) of the passive element 121 are eased because the feed element 122B includes the two separate radiating electrodes 131B and 132B. As a result, impedance adjustment can be easily performed and a desired frequency bandwidth can be achieved. Also in the antenna module 100B according to the third embodiment, the electromagnetic coupling between signals supplied to the feed lines 141B and 142B can be suppressed. The antenna module 100B according to the third embodiment can therefore improve the isolation between radio waves in different polarization directions and improve antenna characteristics.

In the antenna module 100B according to the third embodiment, the distance between the center of the radiating electrode 131B and the center of the radiating electrode 132B is longer than the distance between the center of the radiating electrode 131 and the center of the radiating electrode 132 in the antenna module 100 according to the first embodiment. Accordingly, in the antenna module 100B according to the third embodiment, the occurrence of electric coupling between the radiating electrodes 131B and 132B can be suppressed.

### Fourth Embodiment

The configuration has been described in the first and second embodiments in which parts of the radiating electrodes 131 and 132 overlap the passive element 121. In the fourth embodiment, the configuration will be described in which the whole of a radiating electrode 131C and the whole of a radiating electrode 132C overlap the passive element 121.

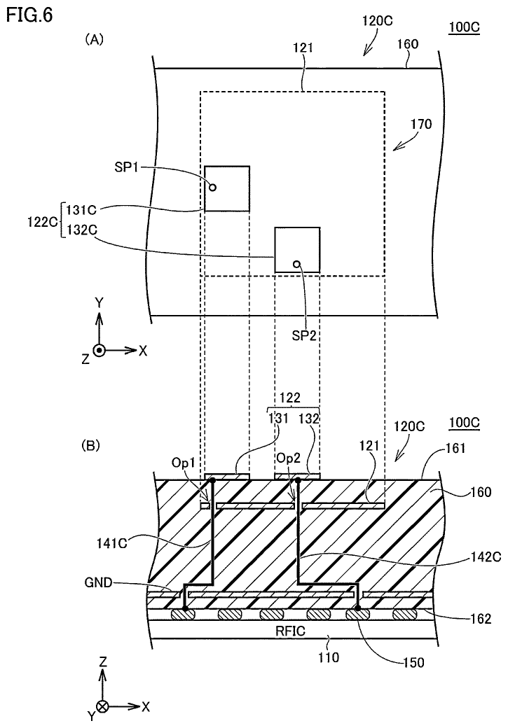

FIG. 6 is a plan view (FIG. 6 (A)) and a side perspective view (FIG. 6 (B)) of an antenna module 100C according to the fourth embodiment. The description of components that are the same as those in the antenna module 100 in FIG. 2 is not repeated with reference to FIG. 6.

As illustrated in FIG. 6, a feed element 122C includes the radiating electrodes 131C and 132C in the antenna module 100C. The radiating electrodes 131C and 132C are disposed at respective positions overlapping the passive element 121 assuming the support substrate 160 is viewed in plan.

The frequency of radio waves radiated by the radiating electrodes 131C and 132C according to the fourth embodiment are higher than that of radio waves radiated by the radiating electrodes 131 and 132 according to the first embodiment. The size of the radiating electrodes 131C and 132C according to the fourth embodiment are therefore smaller than that of the radiating electrodes 131 and 132 according to the first embodiment, and the radiating electrodes 131C and 132C can be disposed at respective positions at which the whole of the radiating electrodes 131C and 132C overlaps the passive element 121.

Thus, also in the case of the configuration according to the fourth embodiment in which the whole of the radiating electrodes 131C and 132C overlaps the passive element 121, the constraints on the positions of through holes (the openings Op1 and Op2) of the passive element 121 are eased because the feed element 122C includes the two separate radiating electrodes 131C and 132C. As a result, impedance adjustment can be easily performed and a desired frequency bandwidth can be achieved. Also in the antenna module 100C according to the fourth embodiment, the electromagnetic coupling between signals supplied to the feed lines 141C and 142C can be suppressed. The antenna module 100C according to the fourth embodiment can therefore improve the isolation between radio waves in different polarization directions and improve antenna characteristics.

In the antenna module 100C according to the fourth embodiment, the whole of the radiating electrodes 131C and 132C overlaps the passive element 121. Accordingly, the influence of the capacitive coupling between the radiating electrode 131C and the ground electrode GND upon the impedance of the radiating electrode 131C is smaller as compared with the second embodiment. In the antenna module 100C according to the fourth embodiment, impedance matching can therefore be more easily performed.

### Fifth Embodiment

An exemplary case where the features of the present disclosure are applied to an array antenna will be described in the fifth embodiment.

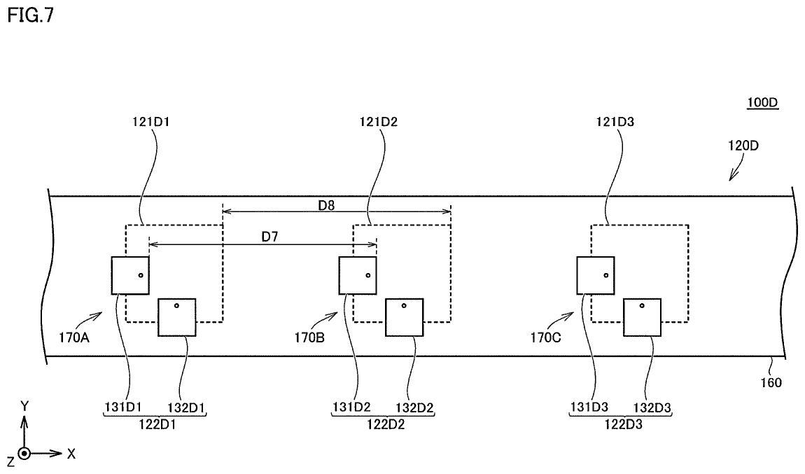

FIG. 7 is a plan view of an antenna module 100D according to the fifth embodiment. The description of a configuration that is the same as that according to the first embodiment is not repeated in the fifth embodiment.

As illustrated in FIG. 7, the radiating elements 170A to 170C are disposed on the support substrate 160. The radiating elements 170A to 170C include passive elements 121D1 to 121D3 and feed elements 122D1 to 122D3, respectively. Also in the fifth embodiment, each of the feed elements 122D1, 122D2, and 122D3 includes two separate radiating electrodes. Radiating electrodes 131D1, 131D2, and 131D3 are evenly disposed at regular spacings of a distance D7. The passive elements 121D1, 121D2, and 121D3 are also evenly disposed at regular spacings of the distance D8.

Thus, also in the case of the configuration of an array antenna according to the fifth embodiment, the constraints on the positions of through holes (the openings Op1 and Op2) of the passive elements 121D1 to 121D3 are eased because each of the feed elements 122D1 to 122D3 includes two separate radiating electrodes. As a result, impedance adjustment can be easily performed and a desired frequency bandwidth can be achieved. Also in the antenna module 100D according to the fifth embodiment, the electromagnetic coupling between signals supplied to the respective feed lines can be suppressed. The antenna module 100D according to the fifth embodiment can therefore improve the isolation between radio waves in different polarization directions and improve antenna characteristics.

The exemplary case has been described with reference to FIG. 7 in which the antenna module 100D according to the fifth embodiment includes the three passive elements 121D1 to 121D3 and the three feed elements 122D1 to 122D3. However, the antenna module 100D may include the four or more passive elements 121D1 and the four or more feed elements 122D1. The radiating element 170A corresponds to a “first radiating element” according to the present disclosure, and the radiating elements 170B and 170C correspond to a “second radiating element” according to the present disclosure.

### Sixth Embodiment

The configuration of an array antenna in which the radiating elements 170 are evenly disposed at regular spacings has been described in the fifth embodiment. In the sixth embodiment, the configuration will be described in which feed elements 122E1 and 122E2 are added to the array antenna according to the fifth embodiment to suppress the occurrence of grating lobes.

### About Grating Lobe

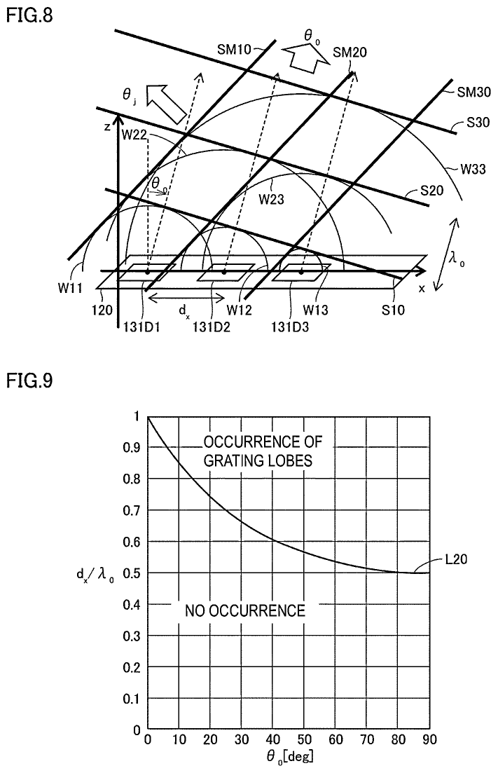

Assuming an array antenna radiates radio waves, grating lobes may occur. Grating lobes are a type of sidelobes and are lobes that occur, in an array antenna in which a spacing between radiating electrodes is equal to or larger than a half wavelength, at an azimuth angle θⱼ different from a specific azimuth angle θ₀ at which phase synthesis is performed and a beam is tilted. The relationship between a spacing between radiating electrodes and grating lobes will be described with reference to FIGS. 8 and 9.

FIG. 8 is a diagram describing a principle of occurrence of grating lobes. As illustrated in FIG. 8, the case will be considered where, in a one-dimensional array antenna in which the radiating electrodes 131D1, 131D2, and 131D3 illustrated in FIG. 7 are focused on, a spacing between electrodes is set as dₓ and the beamforming of a main beam is performed at the azimuth angle θ₀ from the Z-axis direction to the X-axis positive direction.

At that time, by sequentially delaying the phases of radio waves radiated from the radiating electrode 131D1 near the origin in FIG. 8 in the X-axis positive direction, a main beam is radiated at the azimuth angle θ₀. For example, a wave surface in phase with a certain wave surface W11 of a radio wave radiated from the radiating electrode 131D1 is a wave surface W12 in the radiating electrode 131D2 and a wave surface W13 in the radiating electrode 131D3.

Assuming an equiphase wave surface in contact with these in-phase wave surfaces is set as S10, radio waves propagate in a direction perpendicular to the equiphase wave surface S10. In the case of wave surfaces advanced from the equiphase wave surface S10 by one wavelength λ₀, for example, a wave surface W22 of a radio wave from the radiating electrode 131D2 and a wave surface W23 of a radio wave from the radiating electrode 131D3 form an equiphase wave surface S20. In the case of wave surfaces further advanced by the one wavelength λ₀, for example, a wave surface W33 of a radio wave from the radiating electrode 131D3 forms an equiphase wave surface S30. Here, λ₀ represents a space wavelength of a radio wave radiated from a radiating electrode at the time of propagation of the radio wave in space.

On the other hand, in-phase equiphase wave surfaces SM10, SM20, and SM30 are formed by, for example, the wave surface W11 of a radio wave from the radiating electrode 131D1, the wave surface W22 of a radio wave from the radiating electrode 131D2, and the wave surface W33 of a radio wave from the radiating electrode 131D3 which are out of phase with each other by 2nΠ. Radio waves that are propagated by the equiphase wave surfaces SM10, SM20, and SM30 at an azimuth angle θⱼ are grating lobes.

FIG. 9 is a graph indicating conditions under which a grating lobe θ₁ occurs. Referring to FIG. 9, the horizontal axis represents the azimuth angle θ₀ of a main beam and a vertical axis represents a spacing between electrodes. The spacing between electrodes is represented by the ratio of the actual electrode spacing dₓ to the wavelength λ₀ of a radiated radio wave. Assuming the spacings between electrodes corresponding to the respective azimuth angles θ₀ become larger than a solid line L20 in FIG. 9, grating lobes occur. As is apparent from FIG. 9, the larger the spacing between electrodes, the more likely it is that grating lobes occur.

For example, in the case of the azimuth angle θ0=60°, grating lobes occur assuming dₓ/λ₀>0.536 is satisfied. That is, in the case of the azimuth angle θ₀=60°, dₓ needs to be set to a value less than or equal to 0.536 λ₀ for suppression of occurrence of grating lobes.

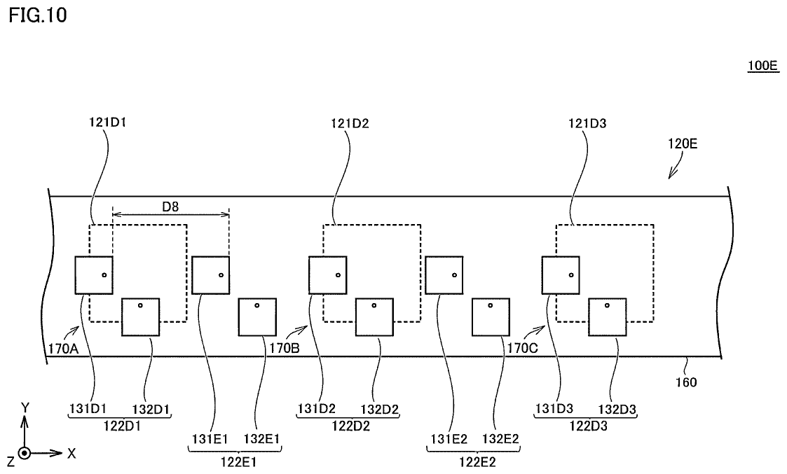

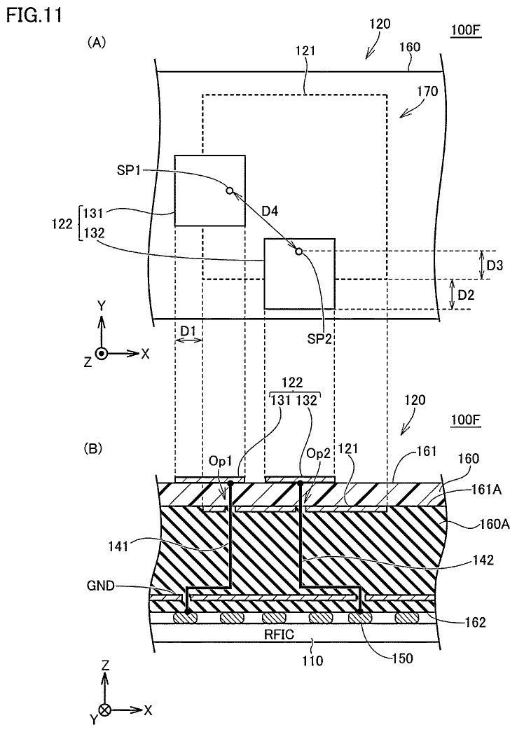

FIG. 10 is a plan view of an antenna module 100E according to a sixth embodiment. The description of a configuration that is the same as that according to the fifth embodiment is not repeated in the sixth embodiment. The antenna module 100E according to the sixth embodiment further includes the feed elements 122E1 and 122E2. The feed element 122E1 includes radiating electrodes 131E1 and 132E1, and the feed element 122E2 includes radiating electrodes 131E2 and 132E2. That is, the feed elements 122E1 and 122E2 have a configuration obtained by removing the passive element 121 from the configuration of the radiating element 170 described with reference to FIG. 2. Accordingly, the radiating electrode 131E1 radiates radio waves of the same frequency as that of radio waves radiated by the radiating electrode 131D1, and the radiating electrode 132E1 radiates radio waves of the same frequency as that of radio waves radiated by a radiating electrode 132D1.

As described above, since the size of the feed element 122D1 on a higher-frequency side is smaller than that of the passive element 121D1 on a lower-frequency side, dₓ/λ₀ increases. Accordingly, the possibility of occurrence of grating lobes in an array antenna formed by the feed element 122D1 is higher than that in an array antenna formed by the passive element 121D1.

In the sixth embodiment, the feed element 122E1 is disposed between the feed elements 122D1 and 122D2 according to the fifth embodiment. The feed element 122E2 is disposed between the feed elements 122D2 and 122D3.

A spacing between electrodes in an array antenna formed of the feed elements 122D1 to 122D3, 122E1, and 122E2 is therefore a distance D8. Since the distance D8 is shorter than the distance D7, dₓ/λ₀ in the feed element 122D1 on a higher-frequency side is smaller as compared with the fifth embodiment and the occurrence of grating lobes can be suppressed.

Also in the case of the configuration of the array antenna according to the sixth embodiment, the constraints on the positions of through holes (the openings Op1 and Op2) of the passive elements 121D1 to 121D3 are eased because each of the feed elements 122D1 to 122D3, 122E1, and 122E2 includes the two separate radiating electrodes. As a result, impedance adjustment can be easily performed and a desired frequency bandwidth can be achieved. Also in the antenna module 100E according to the sixth embodiment, the electromagnetic coupling between signals supplied to the respective feed lines can be suppressed. The antenna module 100E according to the sixth embodiment can therefore improve the isolation between radio waves in different polarization directions and improve antenna characteristics. Each of the feed elements 122E1 and 122E2 corresponds to a “second feed element” according to the present disclosure.

### Seventh Embodiment

The exemplary configuration has been described in the first embodiment in which the antenna device 120 includes the single support substrate 160. In the seventh embodiment, the configuration will be described in which the antenna device 120 includes a support substrate 160A in addition to the support substrate 160. FIG. 11 is a plan view (FIG. 11 (A)) and a side perspective view (FIG. 11 (B)) of an antenna module according to the seventh embodiment. The description of components that are the same as those in the antenna module 100 in FIG. 2 is not repeated with reference to FIG. 11.

As illustrated in FIG. 11 (B), the antenna device 120 includes the support substrate 160A in addition to the support substrate 160 in an antenna module 100F. An upper surface 161A is the surface of the support substrate 160A in the Z-axis positive direction. In the seventh embodiment, the upper surface 161A of the support substrate 160A and the surface of the passive element 121 in the Z-axis positive direction are in the same layer. The support substrate 160 is soldered to the upper surface 161A of the support substrate 160A. The passive element 121 is included in the support substrate 160A.

The support substrate 160A is, for example, an above-described low temperature co-fired ceramics (LTCC) substrate like the support substrate 160. The support substrate 160A does not necessarily have to have a multilayer structure and may be a single-layer substrate. In the seventh embodiment, the support substrate 160 may have a different dielectric constant from the support substrate 160A or the same dielectric constant as the support substrate 160A.

Thus, in the seventh embodiment, the feed element 122 is disposed on the support substrate 160 and the passive element 121 is disposed in the support substrate 160A. That is, the feed elements 122 and 121 are included in different support substrates. Also in the antenna module 100F according to the seventh embodiment, the electromagnetic coupling between signals supplied to the feed lines 141 and 142 can be suppressed like in the first embodiment. The antenna module 100F according to the seventh embodiment can therefore improve the isolation between radio waves in different polarization directions and improve antenna characteristics.

The radiating electrodes 131 and 132 are disposed on the same support substrate 160 in the example illustrated in FIG. 11, but may be disposed on different substrates. That is, a substrate including the radiating electrode 131 and a substrate including the radiating electrode 132 may differ from each other. That is, the support substrate 160 illustrated in FIG. 11 may be divided into a substrate including the radiating electrode 131 and a substrate including the radiating electrode 132.

### Eighth Embodiment

The configuration has been described in the seventh embodiment in which the feed elements 122 and 121 are included in different substrates. In the eighth embodiment, the case will be described in which the support substrate including the ground electrode GND and the support substrate including the feed element 122 and the passive element 121 differ from each other.

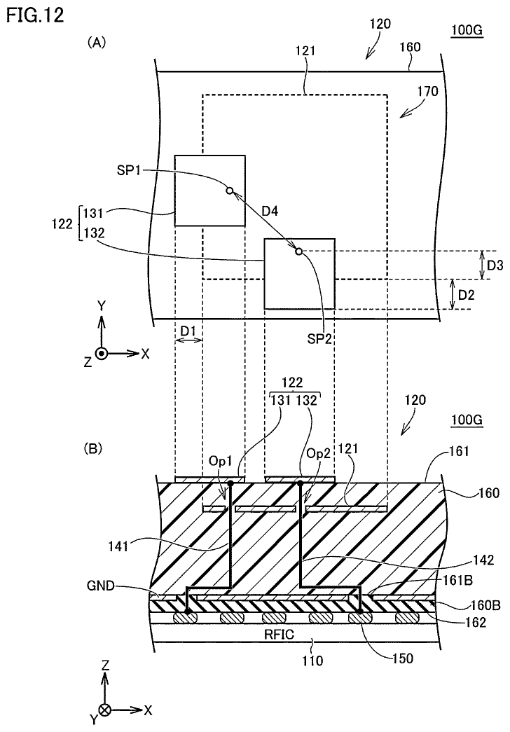

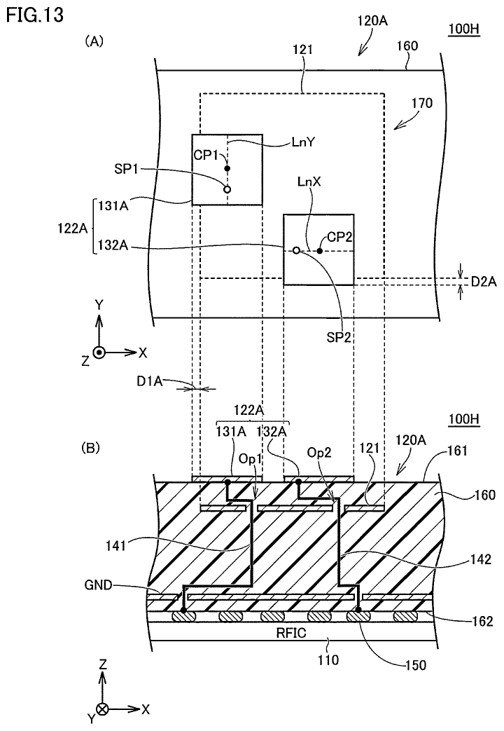

FIG. 12 is a plan view (FIG. 12 (A)) and a side perspective view (FIG. 12 (B)) of an antenna module according to the eighth embodiment. The description of components that are the same as those in the antenna module 100 in FIG. 2 is not repeated with reference to FIG. 12.

As illustrated in FIG. 12 (B), the antenna device 120 in an antenna module 100G according to the eighth embodiment includes a support substrate 160B in addition to the support substrate 160. In the eighth embodiment, an upper surface 161B of the support substrate 160B and the surface of the ground electrode GND in the Z-axis positive direction are in the same layer. The ground electrode GND is included in the support substrate 160B, and the feed element 122 and the passive element 121 are included in the support substrate 160. The upper surface 161B is the surface of the support substrate 160B in the Z-axis positive direction. The support substrate 160 is soldered to the upper surface 161B of the support substrate 160B.

Thus, in the eighth embodiment, the support substrate including the ground electrode GND and the support substrate including the feed element 122 and the passive element 121 differ from each other. Also in the antenna module 100G according to the eighth embodiment, the electromagnetic coupling between signals supplied to the feed lines 141 and 142 can be suppressed like in the first embodiment. The antenna module 100G according to the eighth embodiment can therefore improve the isolation between radio waves in different polarization directions and improve antenna characteristics.

### Ninth Embodiment

The case has been described in the second embodiment in which the feed lines 141 and 142 go straight in the Z-axis positive direction after passing through the openings Op1 and Op2, respectively. In the ninth embodiment, the case will be described in which the feed lines 141 and 142 bend after passing through the openings Op1 and Op2, respectively.

FIG. 13 is a plan view (FIG. 13 (A)) and a side perspective view (FIG. 13 (B)) of an antenna module 100H according to the ninth embodiment. The description of a configuration that is the same as that of the antenna module 100A in FIG. 4 is not repeated with reference to FIG. 13.

As illustrated in FIG. 13, in a path from the RFIC 110 to the radiating electrode 131A in the antenna module 100H, the feed line 141 passes through the opening Op1, bends in the X-axis negative direction, and then extends. After that, the feed line 141 bends again in the Z-axis positive direction and extends to contact the radiating electrode 131A. In a path from the RFIC 110 to the radiating electrode 132A, the feed line 142 similarly passes through the opening Op2, bends in the X-axis negative direction, and then extends. After that, the feed line 142 bends again in the Z-axis positive direction and extends to contact the radiating electrode 132A.

Thus, in the ninth embodiment, the configuration is provided in which the feed lines 141 and 142 bend after passing through the openings Op1 and Op2, respectively. Also in the antenna module 100H according to the ninth embodiment, the electromagnetic coupling between signals supplied to the feed lines 141 and 142 can be suppressed like in the first embodiment. The antenna module 100H according to the ninth embodiment can therefore improve the isolation between radio waves in different polarization directions and improve antenna characteristics.

### Tenth Embodiment

The case has been described in the ninth embodiment in which the feed lines 141 and 142 bend after passing through the openings Op1 and Op2, respectively. In the tenth embodiment, the case will be described in which the feed lines 141 and 142 bend in the same layer as the layer in which the passive element 121 is disposed.

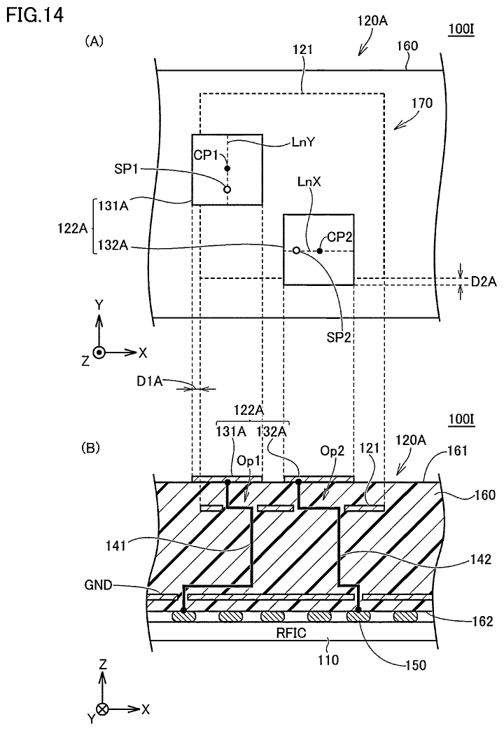

FIG. 14 is a plan view (FIG. 14 (A)) and a side perspective view (FIG. 14 (B)) of an antenna module 100I according to the tenth embodiment. The description of a configuration that is the same as that of the antenna module 100H in FIG. 13 is not repeated with reference to FIG. 14.

As illustrated in FIG. 14, the feed lines 141 and 142 bend in the same layer as the layer in which the passive element 121 is disposed and then extend in the X-axis negative direction in the antenna module 100I. After that, the feed lines 141 and 142 bend again in the Z-axis positive direction and extend to contact the feed element 122A. The openings Op1 and Op2 illustrated in FIG. 14 have larger areas than the openings Op1 and Op2 illustrated in FIG. 13, respectively.

Thus, in the tenth embodiment, the configuration is provided in which the feed lines 141 and 142 bend in the same layer as the layer in which the passive element 121 is disposed. Also in the antenna module 100I according to the tenth embodiment, the electromagnetic coupling between signals supplied to the feed lines 141 and 142 can be suppressed like in the first embodiment. The antenna module 100I according to the tenth embodiment can therefore improve the isolation between radio waves in different polarization directions and improve antenna characteristics.

It is to be understood that the embodiments disclosed herein are illustrative and non-restrictive in all respects. The scope of the present disclosure is not defined by the above description of the embodiments but by the claims and is intended to include meanings equivalent to the claims and all modifications within the scope.

### REFERENCE SIGNS LIST

10 communication apparatus
100, 100A to 100E, and 100Z antenna module
111A to 111D, 113A to 113D, and 117 switch
112AR to 112DR low-noise amplifier
112AT to 112DT power amplifier
114A to 114D attenuator
115A to 115D phase shifter
116 demultiplexer
118 mixer
119 amplification circuit
120 and 120Z antenna device
121, 121D1 to 121D3, and 121Z passive element
122, 122A to 122C, 122D1 to 122D3, 122E1, 122E2, and 122Z feed element
131, 131A to 131C, 131D1 to 131D3, 131Z, 132, 132A to 132C, and 132D1 to 132D3 radiating electrode
141, 141A to 141C, 142, and 142A to 142C feed line
150 bump
160 support substrate
161 upper surface
162 undersurface
D1A, D2A, and D1 to D8 distance
GND ground electrode
L20 solid line
Op1 and Op2 opening
S10 to S30, and SM10 to SM30 equiphase wave surface
SP1 and SP2 feeding point
W11 to W13, W22 and W33 wave surface
dx spacing
170 and 170A to 170C radiating element
CP1 and CP2 center point
LnX and LnY straight line

1. An antenna module comprising:
a flat-shaped support substrate;
a passive element disposed in the support substrate;
a ground electrode facing the passive element;
a feed element that faces the ground electrode and includes a first radiating electrode and a second radiating electrode;
a first feed line that passes through a first through hole formed in the passive element and is connected to a first feeding point of the first radiating electrode; and
a second feed line that passes through a second through hole formed in the passive element and is connected to a second feeding point of the second radiating electrode,
wherein the passive element radiates a radio wave in a first frequency band,
wherein the feed element radiates a radio wave in a second frequency band higher than the first frequency band,
wherein the passive element is disposed between the ground electrode and the feed element in a normal direction of the support substrate,
is capable of radiating a radio wave in a first polarization direction based on a radio frequency signal supplied to the first feed line, and
is capable of radiating a radio wave in a second polarization direction based on a radio frequency signal supplied to the second feed line, and
wherein a polarization direction of the first radiating electrode and a polarization direction of the second radiating electrode differ from each other.

2. The antenna module according to claim 1,
wherein the first radiating electrode radiates a radio wave in the first polarization direction, and
wherein the second radiating electrode radiates a radio wave in the second polarization direction.

3. The antenna module according to claim 1,
wherein the first radiating electrode radiates a radio wave in the second polarization direction, and
wherein the second radiating electrode radiates a radio wave in the first polarization direction.

4. The antenna module according to claim 3,
wherein the first feeding point is disposed at a position offset from a center point of the first radiating electrode in a direction approaching the second radiating electrode on a straight line passing through the center point of the first radiating electrode along the second polarization direction, and
wherein the second feeding point is disposed at a position offset from a center point of the second radiating electrode in a direction approaching the first radiating electrode on a straight line passing through the center point of the second radiating electrode along the first polarization direction.

5. The antenna module according to claim 4, wherein the feed element is disposed at a position where at least a part of the feed element overlaps the passive element assuming the support substrate is viewed in plan.

6. The antenna module according to claim 5, wherein the feed element is disposed at a position where a whole of the feed element overlaps the passive element assuming the support substrate is viewed in plan.

7. The antenna module according to claim 4, wherein the feed element is disposed at a position not overlapping the passive element assuming the support substrate is viewed in plan.

8. The antenna module according to claim 7,
wherein a part of the first feed line extends along a straight line connecting the first through hole and the first feeding point, and
wherein a part of the second feed line extends along a straight line connecting the second through hole and the second feeding point.

9. A communication apparatus equipped with the antenna module according to claim 1.

10. The antenna module according to claim 1, wherein the feed element is disposed at a position where at least a part of the feed element overlaps the passive element assuming the support substrate is viewed in plan.

11. The antenna module according to claim 10, wherein the feed element is disposed at a position where a whole of the feed element overlaps the passive element assuming the support substrate is viewed in plan.

12. The antenna module according to claim 2, wherein the feed element is disposed at a position where at least a part of the feed element overlaps the passive element assuming the support substrate is viewed in plan.

13. The antenna module according to claim 12, wherein the feed element is disposed at a position where a whole of the feed element overlaps the passive element assuming the support substrate is viewed in plan.

14. The antenna module according to claim 1, wherein the feed element is disposed at a position not overlapping the passive element assuming the support substrate is viewed in plan.

15. The antenna module according to claim 2, wherein the feed element is disposed at a position not overlapping the passive element assuming the support substrate is viewed in plan.

16. The antenna module according to claim 3, wherein the feed element is disposed at a position not overlapping the passive element assuming the support substrate is viewed in plan.

17. The antenna module according to claim 1,
wherein a part of the first feed line extends along a straight line connecting the first through hole and the first feeding point, and
wherein a part of the second feed line extends along a straight line connecting the second through hole and the second feeding point.

18. An antenna module comprising:
a flat-shaped support substrate;
a first radiating element;
a second radiating element; and
a ground electrode,
wherein each of the first radiating element and the second radiating element includes,
a passive element that faces the ground electrode and is disposed in the support substrate,
a first feed element that faces the ground electrode and includes a first radiating electrode and a second radiating electrode,
a first feed line that passes through a first through hole formed in the passive element and is connected to the first radiating electrode, and
a second feed line that passes through a second through hole formed in the passive element and is connected to the second radiating electrode,
wherein the passive element radiates a radio wave in a first frequency band,
wherein the first feed element radiates a radio wave in a second frequency band higher than the first frequency band,
wherein, in each of the first radiating element and the second radiating element,
the passive element is disposed between the ground electrode and the first feed element in a normal direction of the support substrate, and
is capable of radiating radio waves in two different polarization directions, and
wherein a polarization direction of the first radiating electrode and a polarization direction of the second radiating electrode differ from each other.

19. The antenna module according to claim 18, further comprising a second feed element that is disposed between the first radiating element and the second radiating element and that is configured to radiate a radio wave in the second frequency band,
wherein the second feed element faces the ground electrode and includes a third radiating electrode and a fourth radiating electrode,
wherein the third radiating electrode is disposed between the first radiating electrode included in the first radiating element and the first radiating electrode included in the second radiating element and radiates a radio wave including a polarized wave in the same polarization direction as the first radiating electrode, and
wherein the fourth radiating electrode is disposed between the second radiating electrode included in the first radiating element and the second radiating electrode included in the second radiating element and radiates a radio wave including a polarized wave in the same polarization direction as the second radiating electrode.

20. A communication apparatus equipped with the antenna module according to claim 18.
